(19) United States
(12) Patent Application Publication
(10) Pub. No.: US 2026/0050437 A1
(43) Pub. Date: Feb. 19, 2026

(54) APPLICATION CREATION

(71) Applicant: Beijing Zitiao Network Technology Co., Ltd., Beijing (CN)

(72) Inventors: Xiaying ZHOU, Beijing (CN); Yiyu HE, Beijing (CN); Jin MA, Beijing (CN); Tianhao WU, Beijing (CN); Zhibin FANG, Beijing (CN); Tao XI, Beijing (CN); Tianran FENG, Beijing (CN); Xianshu GAO, Beijing (CN)

(21) Appl. No.: 19/300,043

(22) Filed: Aug. 14, 2025

(30) Foreign Application Priority Data
Aug. 14, 2024 (CN) 202411118036.X

(51) Int. Cl. G06F 8/71

(52) U.S. Cl. CPC G06F 8/71

(57) ABSTRACT

The embodiments of the disclosure provides a method, apparatus, device and storage medium for application creation. The method includes: selecting, for a model invoking node in a plurality of processing nodes of a target application to be created, a model invocation function block for invoking a first model by the model invoking node from a plurality of function blocks; presenting a configuration interface for the model invocation function block, in response to a configuration request for the model invocation function block; receiving configuration information for the model invocation function block via the configuration interface; and creating the target application based on the configuration information and a workflow composed of the plurality of processing nodes. By the configurability and visualization of the model invocation, the development difficulty of the application with the model invocation capability may be reduced, and the stability of model outputs may be improved.

### CROSS-REFERENCE

This application claims the benefit of Chinese Patent Application No. 202411118036.X, filed on Aug. 14, 2024, entitled “METHOD, APPARATUS, DEVICE, AND STORAGE MEDIUM FOR APPLICATION CREATION”, the entirety of which is incorporated herein by reference.

### FIELD

Example embodiments of the present disclosure generally relate to the field of computers, and in particular, to application creation.

### BACKGROUND

With the development of information technology, various terminal devices may provide various services to people in terms of work and life. An application providing a service may be deployed in a terminal device. The terminal device presents corresponding content and interacts with the user via the user interface of the application to meet various requirements of the user. In some cases, developers may want to develop applications simply and fast. Therefore, how to reduce the difficulty of application development becomes a concern.

### SUMMARY

In a first aspect of the present disclosure, a method for application creation is provided. The method includes: selecting, for a model invoking node in a plurality of processing nodes of a target application to be created, a model invocation function block for invoking a first model by the model invoking node from a plurality of function blocks; presenting a configuration interface for the model invocation function block, in response to a configuration request for the model invocation function block; receiving configuration information for the model invocation function block via the configuration interface; and creating the target application based on the configuration information and a workflow composed of the plurality of processing nodes.

In a second aspect of the present disclosure, an apparatus for application creation is provided. The apparatus includes a selecting module, configured to select, for a model invoking node in a plurality of processing nodes of a target application to be created, a model invocation function block for invoking a first model by the model invoking node from a plurality of function blocks; a presenting module, configured to present a configuration interface for the model invocation function block in response to a configuration request for the model invocation function block; a receiving module, configured to receive configuration information for the model invocation function block via the configuration interface; and a creating module, configured to create the target application based on the configuration information and a workflow composed of the plurality of processing nodes

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The medium stores thereon a computer program, and when the computer program is executed by the processor, the method in the first aspect is implemented.

In a fifth aspect of the present disclosure, there is provided a computer program product having a computer program stored thereon, the computer program being executed by a processor to implement the method according to the first aspect of the present disclosure.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The abovementioned and other features, advantages, and aspects of various embodiments of the present disclosure will become more apparent from the following detailed description with reference to the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 illustrates a flowchart of an application creation process according to some embodiments of the present disclosure;

FIG. 3A to FIG. 3D respectively illustrate schematic diagrams of examples of an application creation interface according to some embodiments of the present disclosure;

FIG. 4 illustrates a flowchart of a process for generating a data query instruction according to some embodiments of the present disclosure;

FIG. 5 illustrate a flowchart of a data processing process according to some embodiments of the present disclosure;

FIG. 6 illustrates a schematic structural block diagram of an apparatus for application creation according to some embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms, and should not be interpreted as limited to the embodiments described in this specification, on the contrary, these embodiments are provided for a more thorough and complete understanding of the present disclosure. It should be understood that the accompanying drawings and embodiments of the present disclosure are only for the purposes of illustration and are not intended to limit the scope of the present disclosure.

In the description of the embodiments of the present disclosure, the terms “including” similar terms would be appreciated as open-ended inclusion, that is “including but not limited to”. The term “based on” would be appreciated as “at least partially based on”. The terms “one embodiment” or “the embodiment” would be appreciated as “at least one embodiment”. The term “some embodiments” would be appreciated as “at least some embodiments”. The following may further include other explicit and implicit definitions may also be included below.

Herein, unless explicitly stated, “responding to A” performs one step and does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It should be understood that before using the technical solutions disclosed in the embodiments of the present disclosure, relevant users should be informed of the types, the scope of use, usage scenarios, and the like of the information related to the present disclosure in an appropriate approach and provide authorization in accordance with relevant laws and regulations, where the relevant users may include any type of rights subject, such as individuals, enterprises, and or groups.

For example, in response to receiving an active request from a user, a prompt is sent to the related user to explicitly indicate the relevant user that the operation requested to be performed requires obtaining and using the information of the relevant user, so that the relevant user can autonomously choose, based on the prompt, whether to provide the information to software or hardware executing the operation of the technical solution of the present disclosure.

As an optional but non-limiting implementation, in response to receiving an active request of a relevant user, the prompt is sent to the relevant user via, for example, a pop-up window, and the prompt information may be presented in a text form in the pop-up window. In addition, the pop-up window may further include a selection control for the user to choose “agree” or “disagree” to provide the information to the electronic device.

It may be understood that the above notification and authorization acquisition process are merely illustrative, and do not limit the implementations of the present disclosure, and other methods that comply with relevant laws and regulations may also be applied to implementations of the present disclosure. The enabling of a digital assistant related function, the acquired data, the approach of data processing and storage, may be subject to prior authorization from the user and other right subjects associated with the, and shall comply with the relevant laws and regulations and the agreed rules under agreements among the rights subjects.

As used herein, the term “model” may learn an association relationship between respective inputs and outputs from training data such that a corresponding output may be generated for a given input after training is completed. The generation of the model may be based on machine learning technologies. Deep learning is a machine learning algorithm that processes inputs and provides corresponding outputs using a multi-layer processing unit. The neural network model is one example of a deep learning-based model. As used herein, a “model” may also be referred to as a “machine learning model,” a “learning model,” a “machine learning network,” or a “learning network,” these terms are used interchangeably herein.

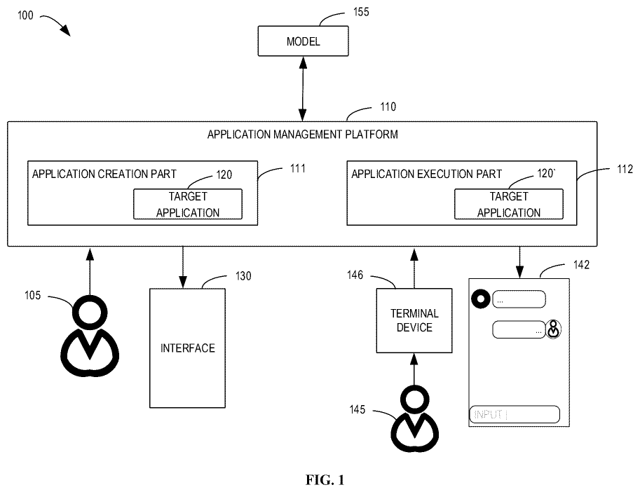

FIG. 1 illustrates a schematic diagram of an example environment 100 in which embodiments of the present disclosure can be implemented. The environment 100 relates to an application management platform 110, which may support the creation of applications and/or the operation of applications. In some embodiments, a part of the application management platform 110 configured to support application creation may also be referred to as an application creation part 111. In some embodiments, a part of the application management platform 110 may also be referred to as an application execution part 112.

As shown in FIG. 1, the application creation part 111 may provide the user 105 with an application creation and posting environment. The user 105 may be referred to as an application creation user or a creator. In some embodiments, the application creation part 111 may be a low code platform that provides a set of tools for application creation. The application creation part 111 may support visual development of various types of applications, so that the developer may bypass the process of manual coding and accelerate the development cycle of the application and reduce cost. The application creation part 111 may support any suitable platform for a user to develop one or more types of applications, for example, including a platform based on application platform-as-a-service (aPaaS). Such platform can support efficient development of applications by users, and implement operations such as application creation and application function adjustment.

The application creation part 111 may be deployed locally on a terminal device of the user 105, and/or may be supported by a server-side device. For example, the terminal device of the user 105 may run a client of the application creation part 111, and the client may support interactions between the user and the application creation part 111 provided by the server-side device. When the application creation part 111 runs locally on the terminal device of the user, the user 105 may directly interact with the local application creation part 111 using the terminal device. When the application creation part 111 runs on the server-side device, the server-side device may provide services to the client running in the terminal device based on a communication connection with the terminal device. The application creation part 111 may present a corresponding interface 130 to the user 105 based on operations of the user 105 to output to and/or receive from the user 105 information related to the application creation.

In some embodiments, the application creation part 111 may be associated to a corresponding database, where data or information required for the application creation process supported by the application creation part 111 is stored. For example, the database may store code and description information corresponding to a respective function block for composing the application. The application creation part 111 may also perform operations such as invoking, adding, deleting, updating, and the like on function blocks in the database. The database may also store operations that may be performed on different function blocks. For example, in a scenario of application creation, the application creation part 111 may invoke a corresponding function module from the database to build the application.

In an embodiment of the present disclosure, the user 105 may create a target application 120 (which may also be referred to as a target application to be created) on the application creation part 111 as needed, and post the target application 120. The target application 120 may be posted to any appropriate application execution part 112, as long as the application execution part 112 is capable of supporting the execution of the target application 120.

After posting, the target application 120′ may be obtained. The target application 120 may be used to be operated by one or more end users 145. The end user 145 may operate the target application 120′ via the associated terminal device 146 and further interact with the application management platform 110. The end user 145 may be referred to as the end user of the target application 120′. In some embodiments, the target application 120′ may include or be implemented as a digital assistant.

The digital assistant may be configured to have an ability of intelligent conversations. The digital assistant may be integrated into the target application 120′ as part of the target application 120′ to assist in performing task processing within the target application 120′. In other examples, the digital assistant may be configured as a stand-alone application, such as a web application or other types of applications. In such an example, the digital assistant and the target application 120′ may be considered as the same application. The digital assistant is provided to assist the user with various task processing needs in different applications and scenarios. During the interaction with the digital assistant, the user inputs an interaction message and the digital assistant provides a reply message in response to the user input. Generally, the digital assistant can support the users to input questions in natural language and perform tasks and provide replies based on the understanding of natural language input and logical reasoning capabilities.

In some embodiments, the digital assistant may interact with the end user 145 as a contact of the end user 145. For example, the digital assistant may be implemented in an instant messaging (IM) application. The digital assistant may interact with the end user 145 in a one-on-one chat session with the end user 145. In some embodiments, the digital assistant may interact with multiple users in a group chat session including multiple users.

For each end user 145, the client of the application execution part 112 may present an interaction window 142 of the target application 120′ or the digital assistant in the client interface, such as a chat window with the digital assistant. The end user 145 may input a chat message in the chat window, and the target application 120′ may determine a reply message of the digital assistant based on created configuration information and present to the user in the interaction window 142. In some embodiments, depending on the configuration of the target application 120′, the interaction message with the target application 120′ may include a message in a multimodal form, such as a text message (e.g., natural language text), a voice message, an image message, a video message, and the like.

Similar to the application creation part 111, the application execution part 112 may be deployed locally at the terminal device of each end user 145, and/or may be supported by the server-side device. For example, the terminal device of the end user 145 may run a client of the application execution part 112, and the client may support interaction between the user and the application execution part 112 provided by the server. When the application execution part 112 runs locally on the terminal device of the user, the end user 145 may directly interact with the local application execution part 112 using the terminal device. When the application execution part 112 executes on the server-side device, the server-side device may provide services to the client running in the terminal device based on the communication connection with the terminal device. The application execution part 112 may present a corresponding application page to the end user 145 based on the operation of the end user 145 to output and/or receive information related to application use to and/or from the end user 145.

In some embodiments, at least part of the functionality of the target application 120′, and/or at least part of the functionality of the digital assistant in the target application 120′ may be implemented based on a model. During the creation or execution of the target application 120′, one or more models 155, such as the capabilities of the model 155, may be invoked. In the target application 120′, the digital assistant may utilize the model 155 to understand the user input and provide a reply to the user based on the output of the model 155.

During the creation process, the test of the target application 120 by the application management platform 110 needs to utilize the model 155 to determine whether the execution result of the target application 120 meets expectations. During the execution, in response to different operation requests of the user of the target application 120′, the application execution part 112 may need to utilize the model 155 to determine a response result to the user.

Although shown as independent from the application management platform 110, one or more models 155 may run on the application management platform 110, or other remote servers. In some embodiments, the model 155 may be a machine learning model, a deep learning model, a learning model, a neural network, or the like. In some embodiments, the model may be based on a language model (LM). The language model may have question-answering capabilities by learning from a large amount of corpora. The model 155 may also be based on other suitable models.

The application management platform 110 may run on a suitable electronic device. The electronic device herein may be any type of device having computing capability, including a terminal device or a server-side device. The terminal device may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. The server-side device may include, for example, a computing system/server, such as a mainframe, an edge computing node, a computing device in a cloud environment, or the like. In some embodiments, the management platform 110 may be implemented based on cloud services.

It should be understood that the structure and function of the environment 100 is described merely for the purpose of illustration and does not imply any limitation to the scope of the present disclosure. For example, although a single user interacting with the application creation part 111 and a single user interacting with the application execution part 112 are illustrated, in practice multiple users may access the application management platform 110 to each create a digital assistant, and each digital assistant may be used to interact with multiple users.

As mentioned above, an application providing a service may be deployed in the terminal device. Traditionally, when a developer develops an application with high stability and high availability, the developer is required to have high software development capabilities, and it usually requires a technician with professional software development skills to complete the development of the application.

With the development of machine learning technologies, machine learning technologies are increasingly widely used in terminal device scenarios. One or more machine learning models are invoked to provide services to users during the operation of some applications. This reduces the difficulty of application development to some extent, enabling more developers to participate in the development process. For example, some companies may develop enterprise-level applications based on usage requirements in enterprise scenarios.

Although the use of machine learning models may reduce the difficulty of application development, developers still need to understand in depth the principles of model operation, prompt engineering and function block construction technologies, and they need to repeatedly configure, debug, and evaluate the application to produce an application with high stability and high availability. Therefore, the developer still wish to further reduce the difficulty of the application development, so that applications may be developed more simply and quickly.

In view of the above, in some embodiments of the present disclosure, an improved solution for application creation is provided. In the solution, for a model invoking node in a plurality of processing nodes of a target application to be created, a model invocation function block for invoking a first model from a plurality of function blocks is selected by the model invoking node; a configuration interface for the model invocation function block is presented, in response to a configuration request for the model invocation function block; configuration information for the model invocation function block via the configuration interface is received; and the target application is created based on the configuration information and a workflow composed of the plurality of processing nodes.

In this way, through an engineering approach, the invocation method of the first model can be configured, and the configuration visualization of the invocation method of the first model can be visualized, which reduces the difficulty of application development with model invocation capabilities and is beneficial for improving the stability of model outputs.

Some example embodiments of the present disclosure will be described in detail below with reference to examples of the accompanying drawings.

The task management process described in the embodiments of the present disclosure may be implemented on an application management platform, a terminal device on which the application management platform is installed, and/or a server corresponding to the application management platform. The following examples, for discussion purposes, will be described from the perspective of the application management platform, for example, the application management platform 110 shown in FIG. 1. The user interface presented by the application management platform 110 may be presented via a terminal device of the user 145, and the application management platform 110 may receive user input via the terminal device of the user 145. In some embodiments of the present disclosure, the user 145 is an end user of the target application 120. It should be understood that the user interface presented by the application management platform 110 may also be presented via the terminal device of the user 105, and the application management platform 110 may also receive the user input via the terminal device of the user 105. In some embodiments of the present disclosure, the user 105 is a creator, manager, or maintainer of the target application 120.

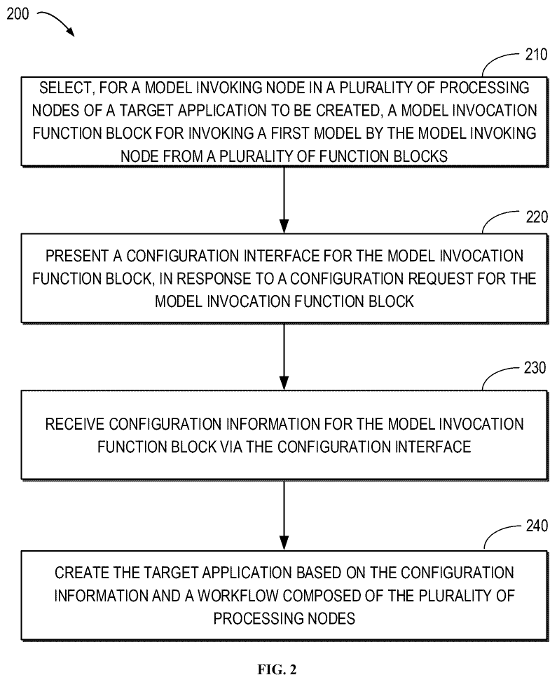

FIG. 2 shows a flowchart of a process 200 for the application creation according to some embodiments of the present disclosure. The process 200 may be implemented at the application management platform 110, e.g., by the application creation part 111 of the application management platform 110. The process 200 shown in FIG. 2 is described below with reference to FIG. 1.

At block 210, the application management platform 110 selects, for a model invoking node in a plurality of processing nodes of the target application 120 to be created, a model invocation function block for the invoking the first model by the model invoking node from a plurality of function blocks. The target application 120 herein may be any type of application, such as a data analytics application, a text generation application, a human resources management application, a finance application, a performance management application, an entertainment application, an electronic office application, or the like.

The processing node herein should be understood as an execution node, a decision node, or a task node in a data processing flow, a workflow, or a business flow of the application, and can represent one or more operations, decisions, or tasks corresponding to the processing node. The target application 120 to be created may include a plurality of processing nodes, such as input nodes, nodes of specific data processing, function invoking nodes, interface invoking nodes, model invoking nodes, recording nodes, logical branch nodes, output nodes, and the like. It may be understood that both the abovementioned application and the processing node of the application are illustrative, and during an actual creation process of the application, processing nodes included in different applications may not be the same.

The function blocks herein should be understood as a collection of programs or systems that may be added to various processing nodes for implementing the operations, decisions, or tasks represented by the processing node. Examples of function blocks may include, but are not limited to, function blocks for performing specific data processing, function blocks for generating data query instructions, function blocks for generating data processing instructions, function blocks for analyzing data, function blocks for invoking functions, function blocks for invoking interfaces, function blocks for invoking models, function blocks for reading and writing, function blocks for decision making or logic judgment, and the like.

In some embodiments, the application management platform 110 may present an application creation interface in response to receiving a creation request for the target application 120. In response to a configuration on the workflow of the target application, present respective node identifiers corresponding to the plurality of processing nodes in the application creation interface together with the connection relationship between the plurality of node identifiers, to indicate the workflow composed of the plurality of processing nodes via the node identifiers and the connection relationship. The application creation interface may include one or more interfaces, such as an application management interface, a process design interface, a page design interface, a data management interface, a permission setting interface, and the like. The node identifiers may be used to identify the processing nodes and/or the function blocks corresponding to the processing node.

In some embodiments, the application management platform 110 may present, in response to the model invoking node selecting a model invocation function block, the node identifier corresponding to the model invocation function block in the application creation interface. For example, in a case where the model invoking node does not select the corresponding model invocation function block, the node identifier may present a first display state. In a case where the model invoking node has determined the corresponding model invocation function block, the node identifier present a second display state.

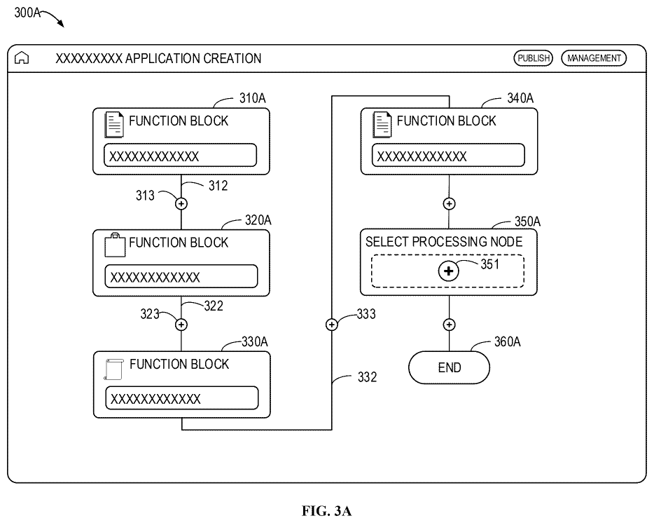

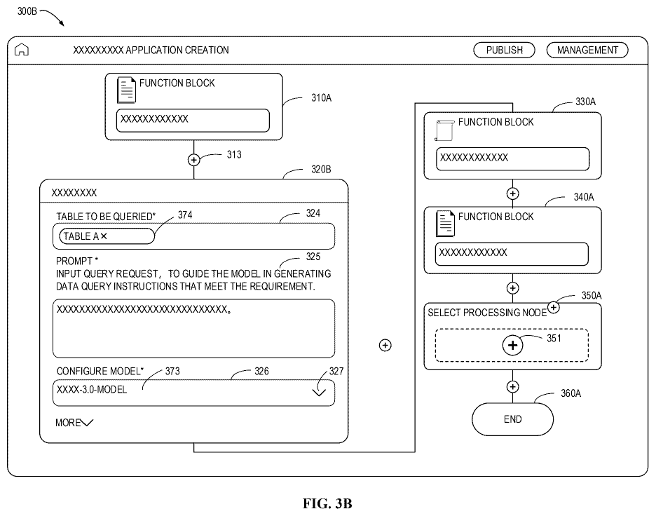

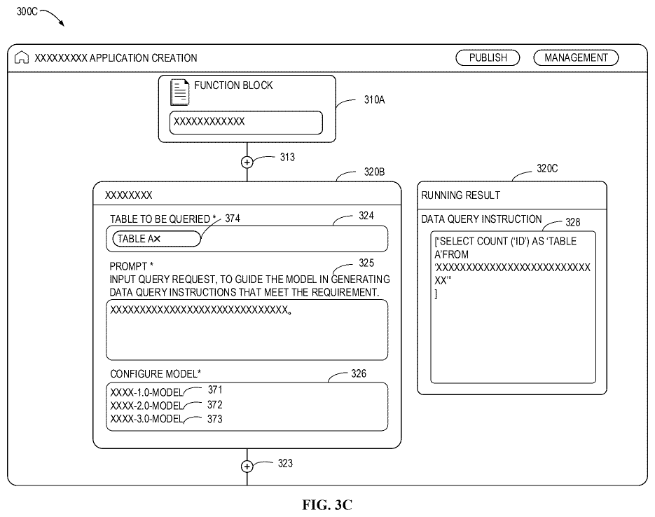

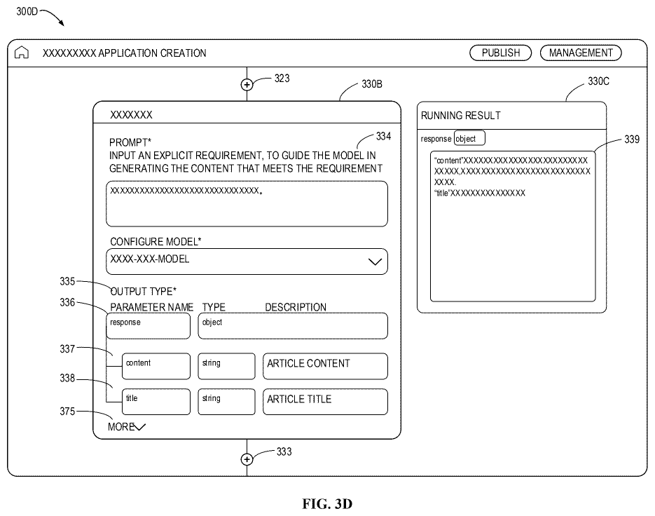

To illustrate the creation of the processing nodes of the target application 120 and the selection of the function blocks, references will be made to FIGS. 3A to 3D for illustrative descriptions. FIG. 3A to FIG. 3D respectively show schematic diagrams of examples 300A to 300D of an application creation interface according to some embodiments of the present disclosure. It should be understood that the interface shown in the drawings is merely an example, and in practice there may be various interface designs. Individual graphical elements in the interface may have different arrangements and different visual representations, one or more of the elements may be omitted or replaced, and one or more other elements may also be present. Embodiments of the present disclosure are not limited in this respect.

The user 105 may configure the application name, the application description, the application icon and the like basic information via the application management interface in the application management platform 110, to initiate the creation process of the target application 120. The application management platform 110 presents the interface shown in the example 300A, in response to the initiation of the creation process of the target application 120, and the example 300A illustrates an example of the application creation interface (e.g., a workflow design interface).

The example 300A includes node identifiers 310A, 320A, 330A, 340A, 350A, 360A, etc. of the plurality of processing nodes. The display states of the node identifiers 310A, 320A, 330A, 340A indicate that the respective processing nodes have selected corresponding, and the display state of the node identifier 350A indicates that the corresponding processing node has not selected a corresponding function block.

For example, in the initial state of the application creation interface, node identifiers may not be displayed, or one or more node identifiers may be displayed as shown in the display state of the node identifier 350A. The node identifier 350A includes a function block add entry 351. The application management platform 110 may present a function block selection interface in response to a trigger of the function block add entry 351. The function block selection interface includes a plurality of candidate function blocks, a candidate function block has preset processing logic and preset information for a predetermined operation and the preset information includes a preset parameter, preset variable, preset condition, preset prompt, and the like.

The application management platform 110 may determine, in response to a selection for any one of the plurality of candidate function blocks, the selected function block as a model invocation function block of the model invoking node corresponding to the node identifier 350. Subsequently, the node identifier 350 switches to a display state similar to that of the node identifiers 310A, 320A, 330A, 340A, presenting the icons and description information of the selected function blocks, and the like.

The example 300A includes connection lines 312 and 322 etc. between the node identifiers, and the connection lines 312 and 322 etc. may be used to identify the connection relationship between the node identifiers, and the connection relationship between the node identifiers may indicate association relationship between the corresponding processing nodes, such as a timing relationship, a logical relationship, a data connection relationship, and the like. A flowchart may be formed via the node identifiers and the connection lines, and the flowchart may refer to the workflow composed of a plurality of processing nodes. Alternatively or additionally, the connection lines 312 and 322 may be preset, or may be added by the application management platform 110 in the interface shown in the example 300A in response to the operation of the user 105.

For example, the interface shown in example 300A, in the initial state, presents the node identifiers 310A, 330A, and the connection line 312 between the node identifiers 310A and 330A, and the connection line 312 is configured to have the node add entry 313. The application management platform 110 may add a node identifier 320A between the node identifier 310A and the node identifier 330A, in response to a trigger on the node add entry 313, connect the node identifier 310A and the node identifier 320A via the connection line 312, and connect the node identifier 320A and the node identifier 330A via the connection line 322.

Certainly, the application creation interface may further include, for example, a node add control, for example, the node add control may be presented in a top menu bar or a side task bar of the application creation interface. The application management platform 110 may present, in response to a trigger of the node add control, a node identifier corresponding to the added processing node on the application creation interface.

Similarly, the application creation interface may further include a connection line add control, and the user adds a connection line to the application creation interface using the connection line add control. For example, by clicking or dragging a connection line, the user may add the connection line between the two node identifiers.

It should be noted that the abovementioned process of creating the processing nodes and selecting the function blocks are merely illustrative. In practice, the application creation page may also only display the node identifiers, or display brief introduction interfaces of the function blocks corresponding to the processing node, and the like.

At block 220, the application management platform 110 presents the configuration interface of the model invocation function block, in response to the configuration request for the model invocation function block. The user may input the configuration request to the application management platform 110 in various ways. In some embodiments, the application management platform may present, in response to receiving a trigger on the node identifier corresponding to the model invoking node, a configuration interface of the model invocation function block.

For example, as shown in FIG. 3A and FIG. 3B, in a scenario where the user needs to configure the function block corresponding to the node identifier 320A, the user may trigger the node identifier 320A via the application management platform 110 or the attached device(s) of the application management platform 110. The application management platform 110 may present the configuration interface 320B shown in the example 300B, in response to a trigger on the node identification 320A.

It may be understood that the above approach of triggering the application management platform 110 to present the configuration interface of the model invocation function block is merely illustrative. In some embodiments, the application management platform 110 may also be triggered to present the configuration interface of the model invocation function block via other approaches. For example, the user may select the node identifier 320A via the application management platform 110 or the attached device(s) of the application management platform 110, and may trigger the application management platform 110 to present the configuration interface by selecting the configuration control in the right key menu or the task bar.

At block 230, the application management platform 110 receives the configuration information for the model invocation function block via the configuration interface. The configuration information may include information such as various parameters, variables, modes, policies, or conditions required for the model invocation function block to perform the corresponding operations, tasks, or decision-making processes. Correspondingly, the configuration interface may include an entry, an input box, or a control for receiving the information. It may be understood that, due to operations required to be performed by different function blocks are different, may resulting in the configuration information required for the different function blocks being different, may further resulting in elements, layouts, and visual representations included in the configuration interfaces of different function blocks being different. The configuration interface will be described below with reference to some examples, but it should not be understood that the configuration interface is limited to the interface design shown below.

In some embodiments, the model invocation function block is configured to invoke the first model to generate the predetermined type of content based on the configuration information. That is, after the target application 120 is created, the application execution part 112 may run the model invocation function block to invoke the first model based on the configuration information for the model invocation function block to generate the predetermined type of content. The predetermined type of content herein may include, but are not limited to, texts, image, audios, videos, program code, structured data with specific structure, and the like. Take the program code as an example, the predetermined type of program code may include, a data query instruction (e.g., a database query instruction written in structured query language), a data processing instruction (e.g., a data processing instruction written in Python programming language), and the like. Certainly, the abovementioned content is merely illustrative, and those skilled in the art may select, according to actual needs, content generated by the invocation model.

In some embodiments, the application management platform 110 may receive, via model configuration entry of the configuration interface, the specified information for the first model, as at least part of the configuration information. The specified information is used to specify a first model for the model invocation function block to generate the predetermined type of content. Alternatively or additionally, the specified information may include, for example, various information that can identify and invoke the first model, such as a name, a number, an interface, and an address of the first model.

The model configuration entry may have various implementation approaches. In some embodiments, the model configuration entry may be implemented as an input box including the invocation address of the first model, and the user may input the invocation address of the first model to the input box via the application management platform 110 or the attached device(s) of the application management platform 110. In this way, after the target application 120 is posted, the application execution part 112 may invoke the first model based on the invocation address.

In some other embodiments, the application management platform 110 may present at least one identifier of the at least one candidate model, in response to receiving a trigger on the model configuration entry. The application management platform 110 may receive a selection on a target identifier from the at least one identifier of the at least one candidate model, and subsequently, in response to the selection, determine that the candidate model corresponding to the target identifier is specified as the first model.

For example, as shown in FIG. 3B and FIG. 3C, the interface shown in the example 300B is presented with the model configuration entry 326, the model configuration entry 326 may include a control 327. The application management platform 110 may switch the display state of the model configuration entry 326 to the display state shown in the example 300C, in response to the trigger of the control 327, and respectively display the identifiers 371, 372, and 373 of the multiple candidate models in the model configuration entry 326, so that the user selects the first model. The application management platform 110 may specify the model corresponding to the selected identifier as the first model, in response to the selection of any one identifier of the identifiers 371, 372, and 373 by the user. For example, if the user selects the identifier 373, the application management platform may specify the model corresponding to the identifier 373 as the first model, and display the identifier 373 in the model configuration entry 326, as shown in FIG. 3B.

In some embodiments, the predetermined type of content may include the data query instruction. The application management platform 110 may receive, as at least part of the configuration information, at least one query condition for generating the data query instruction via a query configuration entry of the configuration interface. The query condition herein is used to filter data that meets certain criterion, and the query condition may include, but is not limited to, a data query range (e.g., a database, a table to be queried, a row in a table, a column in a table, etc.), a data value filtering condition (e.g., greater than, equal to, less than, or equal to etc.), a logic filtering condition (e.g., AND, or NOT, etc.), a fuzzy condition, and the like.

For example, as shown in FIG. 3C, the interface shown in the example 300C may include a query configuration entry 324, and the query configuration entry 324 may be used to receive a table to be queried. The application management platform 110 may present an interface including one or more candidate tables in response to a trigger on the query configuration entry 324. The user may select the table to be queried from the candidate table(s) presented in the interface, the application management platform 110 may determine the selected candidate table as the table to be queried, in response to the selection on the candidate table, and present the identifier 374 of the table to be queried in the query configuration entry 324. Certainly, the user may also input the identifier 374 (e.g., the name of the table) of the table to be queried to the query configuration entry 324.

In some embodiments, the predetermined type of content may include structured data. The application management platform 110 may receive, via an output configuration entry of the configuration interface, structural information of a data structure indicating the structured data, as at least part of the configuration information. The structured data should be understood as data with a standardized format. Alternatively or additionally, the structured data may include, but is not limited to, structs, objects, strings, arrays, tables, and the like. Taking a struct as an example, the struct may include a plurality of fields, and each field may include different types of data. It may be understood that, for different types of structured data, the data structure and structural information may be different, resulting in the interface elements and layouts of the configuration interface being different.

For example, as shown in FIG. 3A and FIG. 3D, the function block corresponding to the node identifier 330A may be used to invoke the first model to generate an article. The application management platform 110 may present the configuration interface 330B shown in the example 300D, in response to a trigger on the node identifier 330A in the interface shown in the example 300A. The configuration interface 330B includes an output configuration entry 335, and the output configuration entry 335 may include multiple groups of input boxes 336, 337, 338, where a group of input boxes 336 includes input boxes used for inputting parameter names and input boxes used for inputting types of structured data, respectively. The user may input “response” in the input box for inputting the parameter name, and may also input, for example, “object” in the input box for inputting the type of the structured data. The group of input boxes 337 and the group of input boxes 338 may respectively include input boxes used for inputting field names, field types, and field descriptions. The user may respectively input “content”, “string”, and “article content” in the group of input boxes 337. The user may also respectively input “title”, “string”, and “article title” in the group of input boxes 338. In this way, the function block corresponding to the node identifier 330A can invoke the first model to generate the article, and can output the generated article as an object named “Response”, the object includes a “title” field and a “content” field, data included in the “title” field is an article title, and data included in the “content” field is article content.

It may be understood that the object is not limited to include the “title” field and the “content” field. The user may also trigger the control 375 in the interface shown in the example 300D, and the application management platform 110 may present one or more groups of input boxes in response to the trigger on the control 375. The user may input field information such as field names, field types, and field descriptions of one or more other fields of the object via the one or more groups of input boxes.

In some embodiments, the application management platform 110 may receive the preset prompt information via the prompt input entry in the configuration interface, where the preset prompt information includes at least the generation requirement(s) for the predetermined type of content. The preset prompt information herein may include the generation requirement(s) for the predetermined type of content written in natural language.

For example, as shown in FIG. 3C, the function block corresponding to the node identifier 320A may be used to invoke the first model to generate the data query instruction. The configuration interface 320B includes a prompt input entry 325 for inputting the prompt. The user may input a query requirement to the prompt input entry 325 using natural language, to guide the model in generating the data query instruction that meets the requirement.

For example, as shown in FIG. 3D, the function block corresponding to the node identifier 330A may be used to invoke the first model to generate the article, and the configuration interface 330B includes a prompt input entry 334 for inputting the prompt. The user may input an explicit requirement for the article to the prompt input entry 334 using natural language, to guide the model in generating the article that meets the requirement.

At block 240, the application management platform 110 creates the target application 120 based on the configuration information and the workflow composed of the plurality of processing nodes.

In some embodiments, after receiving the configuration information for each function block, the application management platform 110 may further test each function block. The application management platform 110 may create the target application 120 based on the configuration information for each function block and the workflow composed of the plurality of processing nodes if the test result indicates that each function block passes the test.

For example, as shown in FIG. 3C, the application management platform 110 may present a running result interface 320C in response to a test on the function block corresponding to the node identifier 320A. The running result interface 320C may include an area 328 for presenting the running result, where the running result of the function block may be presented in the area 328, such as the query instructions generated by invoking the first model. The application management platform 110 may determine, based on the running result, whether the function block corresponding to the node identifier 320A passes the test.

For another example, as shown in FIG. 3D, the application management platform 110 may present a running result interface 330C in response to a test on the function block corresponding to the node identifier 330A. The running result interface 330C may also include an area 339 for presenting the running result, where the running result of the function block may be presented in the area 339, such as the article generated by the function block via invoking the first model, and outputs an object including a “title” field and a “content” field based on the generated article. The application management platform 110 may determine, based on the running result, whether the function block corresponding to the node identifier 330A passes the test.

For example, the application management platform 110 may determine that the test results of the function blocks corresponding to the node identifiers 310A, 320A, 330A, 340A, 350A, 360A indicate a pass, and create the target application 120 based on the configuration information for each function block and a flowchart (e.g., a timing relationship, a logical relationship, a data connection relationship, etc.) of the workflow composed of the plurality of processing nodes. The application file of the target application 120 created by the application management platform 110 records configuration information for each function block and the workflow composed of the plurality of processing nodes.

It may be understood that, in an actual application creation process, it is not limited to process design, but may also include configuration process in multidimension such as page resign, data management, permission setting, account management and the like, thus the actual application creation process is much more complicated than the process described here. However, because the configuration processes in other dimensions during the application creation process are not related to the improved solutions of the embodiments of the present disclosure, the configuration processes in other dimensions such as page design, data management, permission setting, account management and the like is not described in detail herein.

The running process of the posted target application 120′ is described below as an example, and the running process of the target application may be implemented in the application management platform 110, for example, by the application execution part 112 of the application management platform 110. The running process of the target application is described below with reference to FIG. 1.

In some embodiments of the present disclosure, the application management platform 110 may generate target prompt information based on a user input and the configuration information, in response to receiving the user input via the target application 120′. The target prompt information is provided to the first model to obtain the model output. Subsequently, the application management platform 110 may determine reply information for the user input based on the model output.

Alternatively or additionally, the user input may be an input from any suitable user, such as the user input from the end user 145. The user input may be any suitable type of user input, such as texts, voices, images, videos, or the like.

Alternatively or additionally, the application management platform 110 may determine, upon receiving the user input, from a plurality of function blocks of the target application 120′, the model invocation function block that responds to the user input. If the model invocation function block includes the model invocation function block for invoking the first model to generate the predetermined type of content, the target prompt information may be generated based on the configuration information for the model invocation function block and the user input. The target prompt information may be used to prompt the first model for the requirement input by the user, and the target prompt information may include, for example, a prompt or a model input. After receiving the target prompt information, the first model may generate a model output based on the target prompt information, and provide the model data to the application management platform 110.

Alternatively or additionally, the application management platform 110 may obtain historical interaction information matching the user input. For example, the user may interact with the target application 120′ based on multimodal information such as texts, voices, images, videos, etc., and the data generated in this interaction process may be stored as historical interaction information. In the process of answering the current input of the user, the application management platform 110 may obtain the stored historical interaction information, such as questions input by the user or responses fed back by the target application 120′, and the like. The application management platform 110 may obtain structural information and preset prompt information in the configuration information, where the structural information indicates the data structure of the structured data, and the preset prompt information includes a generation requirement for the structured data. The application management platform 110 may generate, using the model invocation function block, the target prompt information for instructing the first model to generate the structured data based on the user input, the historical interaction information, the structural information, and the preset prompt information. Subsequently, the application management platform 110 may provide the target prompt information to the first model, and instruct the first model to generate the model output based on the target prompt information. The application management platform 110 may output, based on the model, reply information for the user input. In this case, the reply information may include the structured data having the data structure indicated by the structural information. After this, the reply information may also be stored as historical interaction information.

Regarding the application management platform 110 determining the reply information for the user input based on the model output, in an example, the application management platform 110 may present at least part of the content in the model output to the user as the reply information. For example, if the user input instructs the target application to generate an article, the first model may generate the article for the user input based on the target prompt information, and at this time, the application management platform 110 may present the specific content of the article to the user.

In another example, the application management platform 110 may invoke the first model via a model invocation function block to obtain the model output. Subsequently, the application management platform 110 may also invoke another function block based on the model output to perform another operation to generate the reply information for the user input. For example, the user input may instruct the target application to perform the data query operation, the application management platform 110 may invoke the first model to generate the data query instruction via a model invocation function block, and then perform the data query operation based on the data query instruction via another function block, and use the queried data as the reply information for the user input.

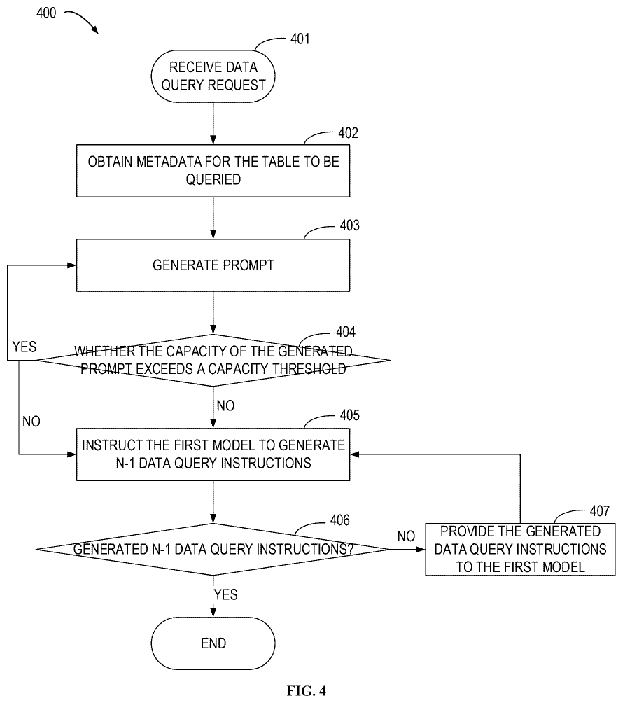

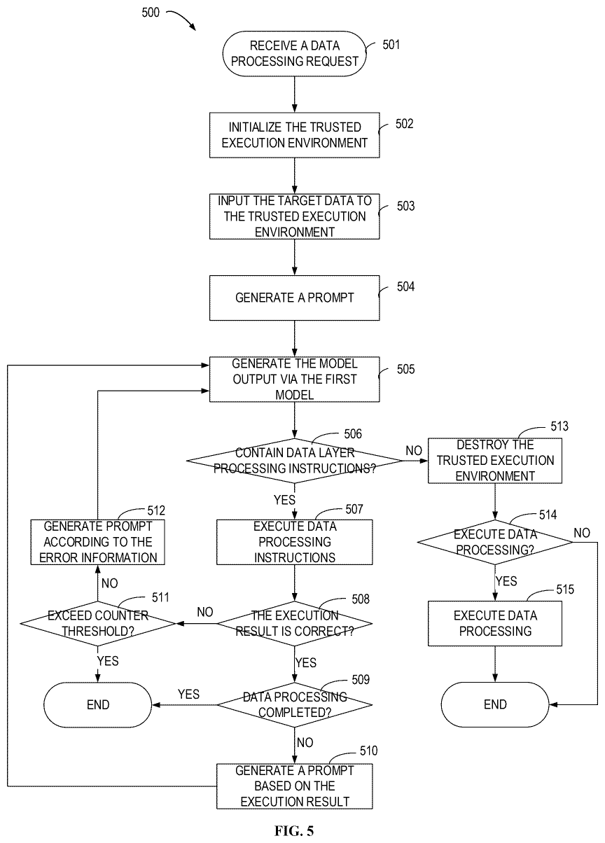

The running process of the function blocks in the target application described below as an example with reference to FIG. 4 and FIG. 5. FIG. 4 is a flowchart of a process 400 for generating data a query instruction according to some embodiments of the present disclosure, and the process 400 shown in FIG. 4 is described below with reference to the environment 100 in FIG. 1 and the function block corresponding to the node identifier 320A in FIG. 3A as the model invoking function block to execute the process 400 shown in FIG. 4 as an example.

At block 401, the application management platform 110 may receive a data query request. The data query request may be triggered by the user, for example, the user may input the data query request via the application management platform 110 or the attached device of the application management platform 110. The data query request may also be triggered by another function block of the application management platform 110. For example, the user input may instruct the target application to generate the article, determine requirement input by the user via the other function block, and generate the data query request in response to requirement input by the user.

At block 402, the application management platform 110 may obtain metadata for the table to be queried. The table to be queried may be recorded in the configuration information for the model invocation function block, or may be determined based on the user input. For example, at least one table to be queried matching the requirement may be determined according to the requirement input by the user. After the at least one table to be queried is determined, the metadata of the at least one table to be queried may be obtained. The metadata is used to describe the table structure and attributes of the table to be queried, such as table name, row information, column information, index, description information, and the like.

At block 403, the application management platform 110 may generate a prompt based on the metadata, the configuration information for the model invocation function block, and the user input.

Alternatively or additionally, before generating the prompt, the application management platform 110 may preprocess the metadata. The preprocessing may include replacing the identification information, such as the table name of the table to be queried, in the metadata with the number (ID), to reduce the data amount of the metadata. The preprocessing may also include normalizing the metadata to process the metadata into data in a particular format. For example, all or part of the data content in the metadata may be processed into data conforming to Database Markup Language (DBML).

Alternatively or additionally, the application management platform 110 is not limited to the prompt generated by the abovementioned information. For example, the application management platform 110 may further obtain environment information (e.g., a date, a time, a current event, a cultural background, etc.), and preset prompt in preset information of the model invocation function block. The application management platform 110 may generate a prompt together with the preset prompt, the user input, and the metadata in the configuration information.

At block 404, the application management platform 110 may determine whether the capacity of the generated prompt exceeds a capacity threshold. The capacity here may indicate the amount of data of the prompt, such as the number of words, bytes, tokens, etc. To prevent the prompt from being too long and affecting the response speed of the first model, the capacity threshold may be preset. After obtaining the prompt, the capacity of the prompt may be compared with the capacity threshold.

If it is determined at block 404 that the capacity of the prompt exceeds the capacity threshold, the process 400 returns to block 403. At block 403, information for generating the prompt may be trimmed. For example, if the data query request includes a plurality of data query processes, the plurality of data query processes may be split, and the prompt may be generated separately for each data query process, to reduce the length of each prompt. For another example, fields in the metadata may be trimmed to reduce the amount of data of the metadata. For another example, the first model may be invoked to determine the target table from the table to be queried to further reduce the number of tables of the required query. Subsequently, the information for generating the prompt may be updated, the prompt be generated based on the updated information, and whether the capacity of the regenerated prompt exceeds the capacity threshold may be determined.

If it is determined at block 404 that the capacity of the prompt does not exceed the capacity threshold, the process 400 proceeds to block 405. At block 405, the application management platform 110 provides the prompt to the first model, to instruct the first model to generate one or more data query instructions.

Alternatively or additionally, the application management platform 110 may provide the prompt to the first model to indicate the number of data query instructions (e.g., N−1) that the first model needs to generate. Subsequently, N−1 data query instructions may be generated by the first model.

At block 406, the application management platform 110 receives the data query instruction generated by the first model, and may determine whether the generation of the N−1 data query instructions is completed. If it is determined at block 406 that the first model has completed the generation of the N−1 data query instructions, the process 400 ends.

If it is determined at block 406 that the first model has not completed the generation of the N−1 data query instructions, the process 400 proceeds to block 407. At block 407, the application management platform 110 provides the generated data query instruction to the first model as part of the prompt, and instructs the first model to generate one or more subsequent data query instructions (e.g., data query instructions conforming to the relational database language).

FIG. 5 shows a flowchart of a data processing process 500 according to some embodiments of the present disclosure, and the process 500 shown in FIG. 5 will be described below with reference to the environment 100 in FIG. 1.

At block 501, the application management platform 110 may receive a data processing request. The data processing request may be triggered by the user, for example, the user may trigger the data processing request via the application management platform 110 or the attached device of the application management platform 110. The data processing request may also be triggered by another function block of the application management platform 110. For example, the user input indicates that the target application generates the article, and the article needs to include a graph and/or a table. The other function block may generate a data processing request, requesting the model invocation function block to invoke the first model to generate a data processing instruction for the graph and/or the table.

At block 502, the application management platform 110 may initialize a trusted execution environment in response to the data processing request. The trusted execution environment may include, but is not limited to, a sandbox.

At block 503, the application management platform 110 may input the target data to the trusted execution environment. The target data may include various data required to generate the data processing instruction, for example, the configuration information and the preset information of the model invoking function block, the user input, the processing result of the previous function block, and the like.

At block 504, the application management platform 110 may generate a prompt based on the target data. Alternatively or additionally, before generating the prompt, the application management platform 110 may perform feature extraction on the target data to obtain feature information of the target data, and may generate the prompt based on the feature information.

At block 505, the application management platform 110 may provide the prompt to the first model, and generate the model output via the first model.

At block 506, the application management platform 110 may determine whether the model output includes a data processing instruction. Alternatively or additionally, the application management platform 110 may determine whether the model data includes the data processing instruction that meets a predetermined condition, such as a data processing instruction conforming to the Python language. Certainly, the predetermined condition may also include other conditions, such as other protocols, other programming languages, and the like.

If it is determined at block 506 that the model output contains data layer care instructions, the process 500 proceeds to block 507. At block 507, the application management platform 110 may perform data processing operations based on the data processing instructions. Alternatively or additionally, data processing instructions may be used to perform any type of data processing, including, but not limited to, data transformation, data cleaning, sorting, various numerical operations, chart generation, and the like.

For example, the data processing instruction may be used to perform an icon generation operation. The application management platform 110 may perform operations such as chart type selection, chart dimension information generation, chart data calculation and the like based on the data processing instruction, and then output the generated chart, for example, a chart conforming to the JSON (JavaScript Object Notation) format.

At block 508, the application management platform 110 may determine whether the execution result of the data processing operation is correct. It may be understood that if the data processing operation is different, the condition to determine whether the execution result is correct may be different. For example, in a case where a data sorting operation is performed, it may be determined whether data sorting has been performed, whether the sorting meets the requirement input by the user, and the like. In a case where the icon generation operation is performed, whether the execution result is correct may be determined from a plurality of dimensions of the chart, such as the name, the row, the column, the graph, the index, etc. of the chart meets the requirements input by the user or the requirements of the data processing request.

If it is determined at block 508 that the execution result of the data processing operation is correct, the process 500 proceeds to block 509. At block 509, the application management platform 110 determines whether the data processing operation is completed. The condition to determine whether the data processing operation is completed mainly depends on the service provided by the target application, the requirement input by the user, the data processing request and the specific type of the data processing operation. For example, in a case where the data processing operation is a chart generation operation, it may be determined whether a chart that meets the requirement input by the user has been generated. If it is determined at block 509 that the data processing operation is completed, the process 500 ends.

If it is determined at block 509 that the data processing operation is not completed, the process 500 proceeds to block 510, where the application management platform 110 generates a prompt according to the execution result, provides the prompt to the first model, continues to generate the data processing instruction via the first model, and executes the data processing operation until it is determined that the data processing operation is completed.

If it is determined at block 508 that the execution result is incorrect, the process 500 proceeds to block 511. At block 511, the application management platform 110 determines whether the current number of retries exceeds a retry threshold. If it is determined at block 511 that the current number of retries has exceeded the retry threshold, the process 500 ends.

If it is determined at block 511 that the current number of retries has not exceeded the retry threshold, the process 550 proceeds to block 512. At block 512, the application management platform regenerates the prompt according to the error information, provides the prompt to the first model, regenerates the data processing instruction via the first model, and executes the data processing operation. The error information is used to identify or describe a specific error of the execution result, and the error information may include, but is not limited to, an error type, an error prompt, an error description, etc. Alternatively or additionally, the error information may include error information of the current execution result, and may further include error information of the previous execution results.

If it is determined at block 506 that the model output of the first model does not include data processing instructions, the process 500 proceeds to block 513. The application management platform 110 destroys the trusted execution environment and the target data input into the trusted execution environment at block 513. For example, the sandbox and target data input into the sandbox may be destroyed.

At block 514, the application management platform 110 may determine whether it is still necessary to perform data processing operations. The application management platform 110 may determine whether to continue to perform the data processing operation according to the operation type of the data processing operation, the data processing capability of the target application, and the requirement input by the user input. For example, the data processing request is used to request to perform a chart generation operation. If it is determined that the first model does not output a data processing instruction for performing the chart generation operation, it is determined whether the target application includes a function block capable of generating the chart that is independent of the first model. If it is determined that the target application is not configured with a function block capable of generating the chart that is independent of the first model, the process 500 may end. If it is determined that the target application has a function block for chart generation that is independent of the first model, it is determined whether the function block for the chart generation may meet the requirement input by the user. If it is determined that the function block for the chart generation is not capable of generating the chart that satisfies the requirement of the user input, the process 500 may end.

If it is determined at block 514 that the data processing operation needs to be continued, the process 500 proceeds to block 515. At block 515, the application management platform 110 continues to perform the data processing operation corresponding to the data processing request. In a case where a data processing result that meets the data processing request is obtained, the data processing process 500 may end. For example, the application management platform 110 invokes a function block for chart generation that is independent of the first model to perform the chart generation operation. The data processing process may end in the event that a chart that meets the requirement of the data processing request or input by the user is obtained.

In summary, according to the embodiments of the present disclosure, the invoking approach of the first model is made configurable using an engineering approach, and the configuration of the invoking approach of the first model may be visualized, which reduces the development difficulty of users (e.g., developer), and improves the stability of model output.

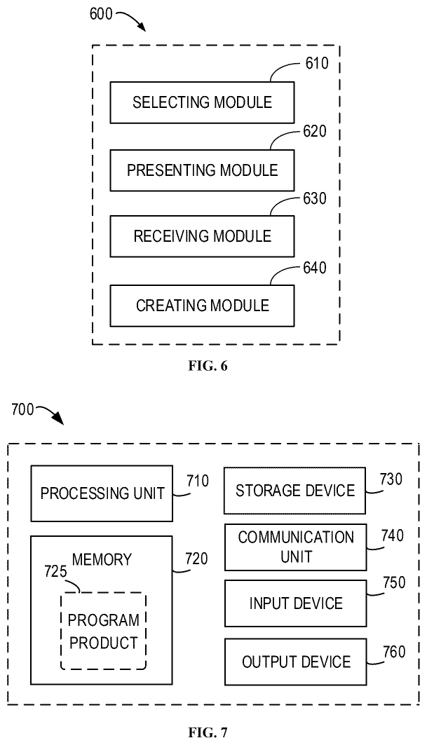

Embodiments of the present disclosure also provide a corresponding apparatus for implementing the above method or process. FIG. 6 is a schematic structural block diagram of an apparatus 600 for application creation according to some embodiments of the present disclosure. The apparatus 600 may be implemented, for example, in or included in the application management platform 110. The various modules/components in the apparatus 600 may be implemented by hardware, software, firmware, or any combination thereof.

As shown, the apparatus 600 may include a selecting module 610, a presenting module 620, a receiving module 630, and a creating module 640. The selecting module 610 is configured to select, for a model invoking node in a plurality of processing nodes of a target application to be created, a model invocation function block for invoking a first model by the model invoking node from a plurality of function blocks. The presenting module 620 is configured to present, in response to a configuration request for the model invocation function block, a configuration interface for the model invocation function block. The receiving module 630 is configured to receive configuration information for the model invocation function block via the configuration interface. The creating module 640 is configured to create the target application based on the configuration information and a workflow composed of the plurality of processing nodes.

In some embodiments, the model invocation function block is configured to invoke the first model based on the configuration information to generate a predetermined type of content.

In some embodiments, the receiving module 630 is further configured to: receive, via a model configuration entry in the configuration interface, specified information for the first model as at least part of the configuration information.

In some embodiments, the receiving module 630 is further configured to: in response to receiving a trigger on the model configuration entry, present at least one identifier of at least one candidate model; receive a selection on a target identifier from the at least one identifier of the at least one candidate model; and in response to the selection, determine that a candidate model corresponding to the target identifier is specified as the first model.

In some embodiments, the predetermined type of content includes structured data, and the receiving module 630 is further configured to: receive as at least part of the configuration information, via an output configuration entry of the configuration interface, structural information of a data structure indicating the structured data.

In some embodiments, the predetermined type of content includes a data query instruction, and the receiving module 630 is further configured to: receive as at least part of the configuration information, via a query configuration entry of the configuration interface, at least one query condition used to generate the data query instruction.

In some embodiments, the receiving module 630 is further configured to: receive preset prompt information via a prompt input entry in the configuration interface, the preset prompt information at least including a generation requirement for the predetermined type of content.

In some embodiments, the apparatus 600 further includes a response module configured to: in response to receiving a creation request for the target application, present an application creation interface; and in response to a configuration on a workflow of the target application, present, in the application creation interface, respective node identifiers corresponding to the plurality of processing nodes and a connection relationship between the plurality of node identifiers, to indicate the workflow with the node identifiers and the connection relationship.

In some embodiments, the response module is further configured to present, in response to a selection of the model invocation function block for the model invoking node, a node identifier corresponding to the model invocation function block in the application creation interface.

In some embodiments, the presentation module 620 is further configured to present, in response to receiving a trigger on a node identifier corresponding to the model invoking node, the configuration interface of the model invocation function block.

In some embodiments, the apparatus 600 further includes a running module configured to, in response to receiving the user input via the target application, generate target prompt information based on the user input and the configuration information; provide the target prompt information to the first model to obtain a model output; and determine reply information for the user input based on the model output.

In some embodiments, the running module is further configured to: obtain historical interaction information matching the user input; obtain structural information and preset prompt information in the configuration information, the structural information indicating a data structure of the structured data, and the preset prompt information including a generation requirement for the structured data; and generate, using the model invocation function block and based on the user input, the historical interaction information, the structure information, and the preset prompt information, the target prompt information to indicate the first model to generate structured data.

The units and/or modules included in the apparatus 600 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 600 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 7 illustrates a block diagram of an electronic device 700 in which one or more embodiments of the present disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may include or be implemented as the application management platform 110 of FIG. 1 or the device 600 of FIG. 6.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of electronic device 700.

Electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device via a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. The electronic device 700 may also communicate with one or more external devices (not shown) via the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for application creation, comprising:
selecting, for a model invoking node in a plurality of processing nodes of a first application under construction, a model invocation function block for invoking a first model by the model invoking node from a plurality of function blocks;
presenting a configuration interface for the model invocation function block, in response to a configuration request for the model invocation function block;
receiving configuration information for the model invocation function block via the configuration interface; and
creating the first application based on the configuration information and a workflow composed of the plurality of processing nodes.

2. The method of claim 1, wherein the model invocation function block is configured to invoke the first model based on the configuration information to generate a first type of content.

3. The method of claim 2, wherein receiving the configuration information for the model invocation function block via the configuration interface comprises:
receiving, via a model configuration entry in the configuration interface, specified information for the first model as at least part of the configuration information.

4. The method of claim 3, wherein receiving the specified information for the first model via the model configuration entry comprises:
presenting at least one identifier of at least one candidate model, in response to receiving a trigger on the model configuration entry;
receiving a selection on a first identifier from the at least one identifier of the at least one candidate model; and
determining, in response to the selection, that a candidate model corresponding to the first identifier is specified as the first model.

5. The method of claim 2, wherein the first type of content comprises structured data, and receiving the configuration information for the model invocation function block via the configuration interface comprises:
receiving as at least part of the configuration information, via an output configuration entry of the configuration interface, structural information of a data structure indicating the structured data.

6. The method of claim 2, wherein the first type of content comprises a data query instruction, and receiving the configuration information for the model invocation function block via the configuration interface comprises:
receiving as at least part of the configuration information, via a query configuration entry of the configuration interface, at least one query condition for generating the data query instruction.

7. The method of claim 2, wherein receiving the configuration information for the model invocation function block via the configuration interface comprises:
receiving preset prompt information via a prompt input entry in the configuration interface, the preset prompt information at least comprising a generation requirement for the first type of content.

8. The method of claim 1, further comprising:
presenting, in response to receiving a creation request for the first application, an application creation interface; and
in response to a configuration on a workflow of the first application, presenting, in the application creation interface, respective node identifiers corresponding to the plurality of processing nodes and a connection relationship between the plurality of node identifiers, to indicate the workflow with the node identifiers and the connection relationship.

9. The method of claim 8, further comprising:
presenting in the application creation interface, in response to a selection of the model invocation function block for the model invoking node, a node identifier corresponding to the model invocation function block.

10. The method of claim 9, wherein presenting the configuration interface for the model invocation function block comprises:
presenting the configuration interface for the model invocation function block in response to receiving a trigger on a node identifier corresponding to the model invoking node.

11. The method of claim 1, further comprising:
generating, using the model invocation function block, first prompt information based on an user input and the configuration information in response to receiving the user input via the first application;
providing, using the model invocation function block, the first prompt information to the first model to obtain a model output; and
determining reply information for the user input based on the model output.

12. The method of claim 11, wherein generating the first prompt information comprises:
obtaining historical interaction information matching the user input;
obtaining structural information and preset prompt information in the configuration information, the structural information indicating a data structure of structured data, and the preset prompt information comprising a generation requirement for the structured data; and
generating, using the model invoking function block and based on the user input, the historical interaction information, the structure information, and the preset prompt information, the first prompt information to indicate the first model to generate structured data.

13. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
selecting, for a model invoking node in a plurality of processing nodes of a first application under construction, a model invocation function block for invoking a first model by the model invoking node from a plurality of function blocks;
presenting a configuration interface for the model invocation function block, in response to a configuration request for the model invocation function block;
receiving configuration information for the model invocation function block via the configuration interface; and
creating the first application based on the configuration information and a workflow composed of the plurality of processing nodes.

14. The electronic device of claim 13, wherein the model invocation function block is configured to invoke the first model based on the configuration information to generate a first type of content.

15. The electronic device of claim 14, wherein receiving the configuration information for the model invocation function block via the configuration interface comprises:
receiving, via a model configuration entry in the configuration interface, specified information for the first model as at least part of the configuration information.

16. The electronic device of claim 15, wherein receiving the specified information for the first model via the model configuration entry comprises:
presenting at least one identifier of at least one candidate model, in response to receiving a trigger on the model configuration entry;
receiving a selection on a first identifier from the at least one identifier of the at least one candidate model; and
determining, in response to the selection, that a candidate model corresponding to the first identifier is specified as the first model.

17. The electronic device of claim 14, wherein the first type of content comprises structured data, and receiving the configuration information for the model invocation function block via the configuration interface comprises:
receiving as at least part of the configuration information, via an output configuration entry of the configuration interface, structural information of a data structure indicating the structured data.

18. The electronic device of claim 14, wherein the first type of content comprises a data query instruction, and receiving the configuration information for the model invocation function block via the configuration interface comprises:
receiving as at least part of the configuration information, via a query configuration entry of the configuration interface, at least one query condition for generating the data query instruction.

19. The electronic device of claim 14, wherein receiving the configuration information for the model invocation function block via the configuration interface comprises:
receiving preset prompt information via a prompt input entry in the configuration interface, the preset prompt information at least comprising a generation requirement for the first type of content.

20. A non-transitory computer readable storage medium having a computer program stored thereon, which is executable by a processor to implement operations comprising:
selecting, for a model invoking node in a plurality of processing nodes of a first application under construction, a model invocation function block for invoking a first model by the model invoking node from a plurality of function blocks;
presenting a configuration interface for the model invocation function block, in response to a configuration request for the model invocation function block;
receiving configuration information for the model invocation function block via the configuration interface; and
creating the first application based on the configuration information and a workflow composed of the plurality of processing nodes.
